(19) United States
(12) Patent Application Publication
(10) Pub. No.: US 2025/0233252 A1
(43) Pub. Date: Jul. 17, 2025

(54) POWER STORAGE DEVICE

(71) Applicant: TOYOTA JIDOSHA KABUSHIKI KAISHA, Toyota-shi (JP)

(72) Inventors: Kazuki SUGIE, Miyoshi-shi (JP); Akio MORI, Toyota-shi (JP); Yoshiro KAMO, Ashigarakami-gun (JP); Takahiko NAKANO, Nagoya-shi, (JP); Toshihiro SHIMONAKA, Toyota-shi (JP); Kenichi KOHASHI, Sunto-gun (JP); Yuki SODA, Nagoya-shi (JP)

(73) Assignee: TOYOTA JIDOSHA KABUSHIKI KAISHA, Toyota-shi (JP)

(21) Appl. No.: 18/951,917

(22) Filed: Nov. 19, 2024

(30) Foreign Application Priority Data
Jan. 15, 2024 (JP) 2024-003918

(51) Int. Cl. H01M 50/262; H01M 10/613; H01M 10/647; H01M 50/209

(52) U.S. Cl. CPC H01M 50/262; H01M 10/613; H01M 10/647; H01M 50/209

(57) ABSTRACT

A power storage device includes: a plurality of power storage cells; and a case that accommodates the plurality of power storage cells. The case includes a cooling plate and a bottom surface that are fixed to the plurality of power storage cells. In the power storage device, a hollow member is disposed between the plurality of power storage cells and each of the cooling plate and the bottom surface.

### CROSS REFERENCE TO RELATED APPLICATIONS

This nonprovisional application is based on Japanese Patent Application No. 2024-003918 filed on Jan. 15, 2024 with the Japan Patent Office, the entire contents of which are hereby incorporated by reference.

### BACKGROUND

### Field

The present disclosure relates to a power storage device.

### Description of the Background Art

Japanese Patent Laying-Open No. 2021-111520 discloses a battery pack including a plurality of battery cells and a battery pack case. Each of the plurality of battery cells is bonded to a floor surface of the battery pack case.

### SUMMARY

Removal of a battery cell from a battery pack case is necessary at the time of recycling or the like of the battery cell. However, in the battery pack described in Japanese Patent Laying-Open No. 2021-111520, each of the battery cells is bonded to the floor surface of the battery pack case, and thus, removal of each of the battery cells (power storage cells) is difficult.

The present disclosure has been made to solve the above-described problem, and an object thereof is to provide a power storage device in which a power storage cell can be easily removed from a case.

A power storage device according to an aspect of the present disclosure includes: at least one power storage cell; and a case that accommodates the at least one power storage cell. The case includes at least one fixed portion fixed to the at least one power storage cell. A fragile portion is formed between the at least one power storage cell and the at least one fixed portion.

In the power storage device according to the aspect of the present disclosure, the fragile portion is formed between the at least one power storage cell and the at least one fixed portion as described above. Thus, the at least one fixed portion can be easily separated from the at least one power storage cell, starting from the fragile portion. Therefore, the power storage cell can be easily removed from the case.

Preferably, the power storage device according to the aspect described above further includes a fragile member having a rigidity lower than that of each of the case and the at least one power storage cell. The fragile portion is formed by disposing the fragile member between the at least one power storage cell and the at least one fixed portion. With such a configuration, since the fragile member is disposed, the fragile portion can be easily formed between the at least one power storage cell and the at least one fixed portion.

In this case, preferably, the fragile member includes a hollow member. With such a configuration, the hollow member can be easily broken, starting from a hollow space of the hollow member.

Preferably, in the power storage device having the fragile member disposed therein, the fragile member is provided separately from each of the at least one power storage cell and the case. With such a configuration, even when the fragile member is broken, breaking of the power storage cell and the case can be suppressed.

Preferably, the power storage device having the fragile member disposed therein includes an insulating film provided to wrap the at least one power storage cell, together with the fragile member. With such a configuration, the fragile member and the power storage cell can be integrally held by the insulating film, and thus, the fragile member can be easily fixed to the power storage cell. As a result, the at least one power storage cell and the fragile member can be treated as one unit. Thus, a manufacturing process (assembly process) of the power storage device can be simplified.

Preferably, in the power storage device having the fragile member disposed therein, the case includes a cooling device that cools the at least one power storage cell. The fragile member is fixed to the cooling device. With such a configuration, the fragile portion can be formed by the fragile member and the power storage cell can be cooled by the cooling device.

Preferably, in the power storage device having the fragile member disposed therein, a breaking start point portion serving as a start point of breaking is provided in the fragile member. With such a configuration, the fragile member can be easily broken, starting from the breaking start point portion. As a result, the at least one fixed portion can be more easily separated from the at least one power storage cell.

Preferably, in the power storage device according to the aspect described above, the at least one power storage cell includes a plurality of power storage cells. The fragile portion is formed between each of the plurality of power storage cells and the at least one fixed portion. With such a configuration, the case can be easily separated from each of the plurality of power storage cells.

Preferably, in the power storage device according to the aspect described above, the at least one power storage cell includes a plurality of power storage cells. The plurality of power storage cells are disposed to be arranged side by side in a first direction. The fragile portion is formed to extend in the first direction so as to be provided over a region where the plurality of power storage cells are disposed. With such a configuration, the case can be separated from the plurality of power storage cells, starting from one fragile portion. As a result, the number of the fragile portion can be reduced, as compared with when the fragile portion is provided at a position corresponding to each of the plurality of power storage cells. As a result, an excessive decrease in rigidity of the power storage device can be suppressed.

Preferably, in the power storage device according to the aspect described above, the case includes a bottom surface supporting the at least one power storage cell from below, and an upper surface provided to cover the at least one power storage cell from above. The at least one fixed portion includes at least one of the bottom surface and the upper surface. With such a configuration, at least one of the bottom surface and the upper surface can be easily separated from the power storage cell by the fragile portion.

Preferably, in the power storage device according to the aspect described above, the at least one power storage cell has a prismatic shape formed to extend in a second direction. The fragile portion is formed to extend in the second direction along the at least one power storage cell. With such a configuration, the fragile portion can be larger (longer), as compared with when the fragile portion does not extend in the second direction in which the power storage cell extends. As a result, the case can be more easily separated from the power storage cell.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a configuration of a power storage device according to an embodiment.

FIG. 2 is a cross-sectional view of a power storage module according to the embodiment.

FIG. 3 is a perspective view showing configurations of a power storage cell and a hollow member according to the embodiment.

FIG. 4 is a cross-sectional view taken along line IV-IV in FIG. 1.

FIG. 5 is a cross-sectional view of a power storage module according to a first modification of the embodiment.

FIG. 6 is a cross-sectional view of a power storage module according to a second modification of the embodiment.

FIG. 7 is a cross-sectional view of a power storage module according to a third modification of the embodiment.

FIG. 8 is a cross-sectional view of a power storage module according to a fourth modification of the embodiment.

FIG. 9 is a cross-sectional view of a power storage module according to a fifth modification of the embodiment.

### DESCRIPTION OF THE PREFERRED EMBODIMENTS

Hereinafter, an embodiment of the present disclosure will be described in detail with reference to the drawings. In the drawings, the same or corresponding portions are denoted by the same reference characters and description thereof will not be repeated.

In the present specification, the up-down direction is defined as the Z direction. Specifically, the upper side is defined as the Z1 side, and the lower side is defined as the Z2 side. Each of the X direction and the Y direction is a direction orthogonal to the Z direction (i.e., horizontal direction). The X direction is orthogonal to the Y direction. The X direction and the Y direction are examples of “first direction” and “second direction” in the present disclosure, respectively.

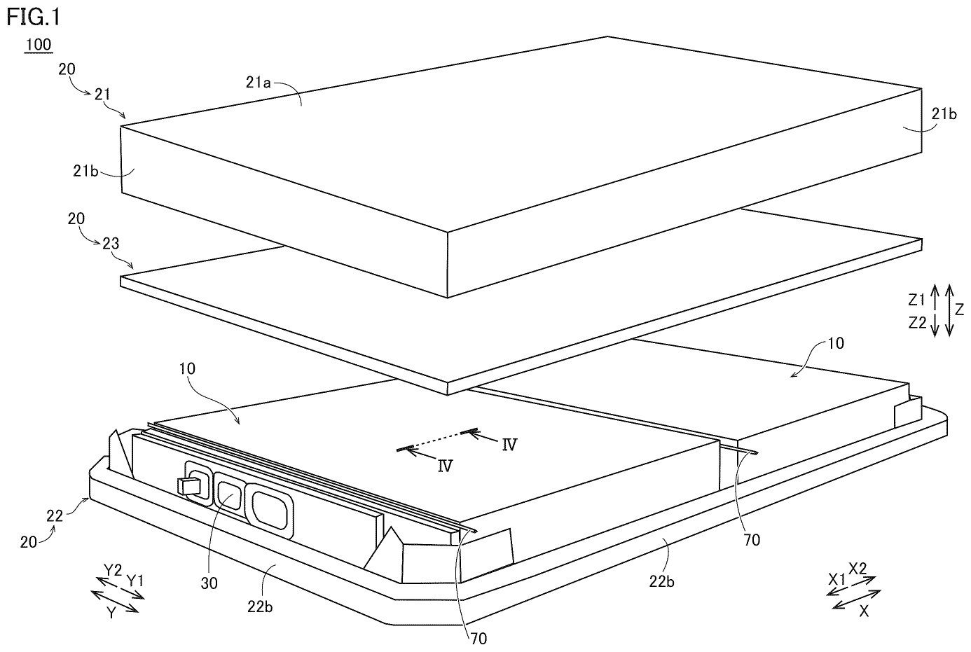

FIG. 1 is a perspective view showing a configuration of a power storage device 100 according to the present embodiment. Power storage device 100 is, for example, a device for storing electric power for driving an electrically powered vehicle (not shown). The X direction shown in FIG. 1 corresponds to the front-back direction of the electrically powered vehicle, for example. The Y direction corresponds to the left-right direction of the electrically powered vehicle.

Power storage device 100 includes a plurality of (in the present embodiment, two) power storage modules 10 and a case 20. The number of power storage modules 10 is not limited to the above-described example. One or three or more power storage modules 10 may be provided.

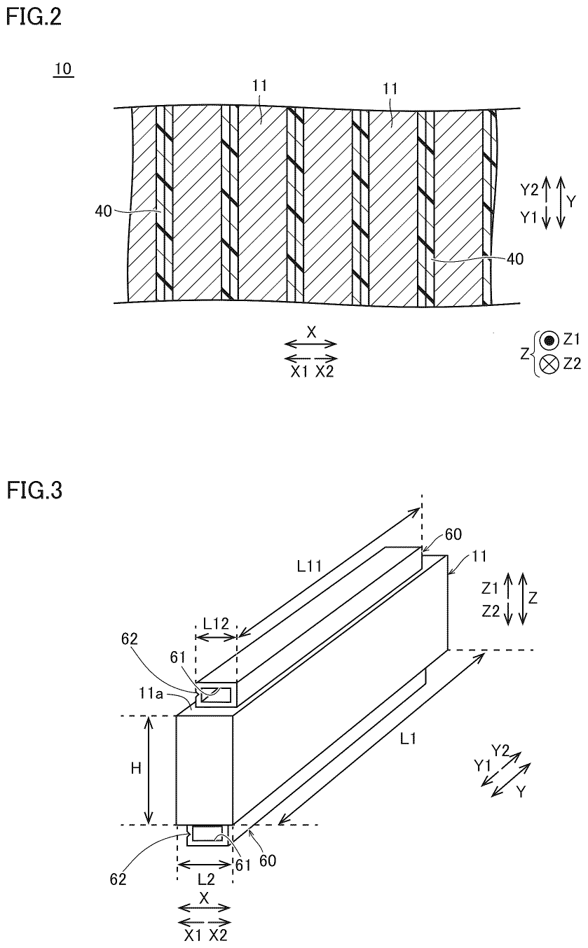

FIG. 2 is a cross-sectional view of power storage module 10. Each of the plurality of power storage modules 10 includes a plurality of power storage cells 11. Each of the plurality of power storage cells 11 is formed to extend in the Y direction. The plurality of power storage cells 11 are disposed to be arranged side by side in the X direction. Each of the plurality of power storage cells 11 may be disposed to extend in the X direction.

FIG. 3 is a perspective view showing a configuration of power storage cell 11. Power storage cell 11 has a prismatic shape formed to extend in the Y direction. Specifically, power storage cell 11 has a length L1 in the Y direction. Power storage cell 11 has a length L2 in the X direction. Length L1 is longer than length L2. Power storage cell 11 also has a height H in the Z direction. Length L1 is greater than height H. For the sake of simplification, FIG. 3 only shows one power storage cell 11 and a below-described hollow member 60.

Referring again to FIG. 1, case 20 accommodates the plurality of power storage modules 10. Case 20 includes an upper case 21, a lower case 22 and a cooling plate 23. The plurality of power storage modules 10 are accommodated in a space formed by mounting upper case 21 onto lower case 22. Cooling plate 23 is also accommodated in the above-described space. Cooling plate 23 is an example of “cooling device” and “fixed portion” in the present disclosure.

Upper case 21 is provided to cover the plurality of power storage modules 10 from the Z1 side. Upper case 21 has an upper surface 21a and a plurality of (e.g., four) side surfaces 21b. Upper surface 21a is provided to face the plurality of power storage modules 10 in the Z direction. Each of the plurality of side surfaces 21b is connected to upper surface 21a. Specifically, each of the plurality of side surfaces 21b is provided to extend from an outer perimeter edge of upper surface 21a to the Z2 side. The plurality of power storage modules 10 are disposed at a position where the plurality of power storage modules 10 are surrounded by the plurality of side surfaces 21b when viewed from the Z1 side. Upper case 21 is made of resin, for example.

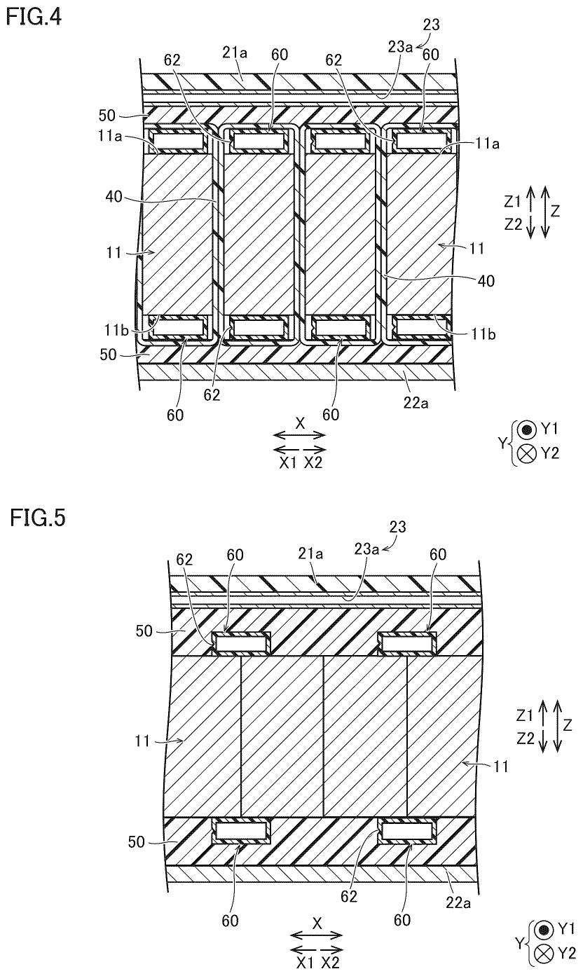

Lower case 22 is provided to support the plurality of power storage modules 10 from the Z2 side. Lower case 22 has a bottom surface 22a (see FIG. 4) and a plurality of side surfaces 22b. Bottom surface 22a is provided to face the plurality of power storage modules 10 in the Z direction. Each of the plurality of side surfaces 22b is connected to bottom surface 22a. Specifically, the plurality of side surfaces 22b are provided to extend from an outer perimeter edge of bottom surface 22a to the Z1 side. The plurality of power storage modules 10 are disposed at a position where the plurality of power storage modules 10 are surrounded by the plurality of side surfaces 22b when viewed from the Z1 side. Side surfaces 21b of upper case 21 are connected to side surfaces 22b of lower case 22, whereby upper case 21 is mounted onto lower case 22. Bottom surface 22a is an example of “fixed portion” in the present disclosure.

Cooling plate 23 is provided to cover the plurality of power storage modules 10 from the Z1 side. Specifically, cooling plate 23 is provided between upper surface 21a of upper case 21 and the plurality of power storage modules 10. A flow path 23a (see FIG. 4) through which a cooling liquid flows is provided in cooling plate 23. Each of the plurality of power storage modules 10 is cooled by the cooling liquid flowing through flow path 23a of cooling plate 23.

Power storage device 100 includes a relay box 30. Relay box 30 is disposed on the X1 side with respect to power storage module 10 on the X1 side. Relay box 30 accommodates a plurality of relays that control on and off of a current flowing from the outside of power storage device 100 to power storage device 100 (or a current flowing from power storage device 100 to the outside). Relay box 30 is also accommodated in case 20.

FIG. 4 is a cross-sectional view taken along line IV-IV in FIG. 1. As shown in FIG. 4, each of the plurality of power storage cells 11 is wrapped by an insulating film 40. Thus, power storage cells 11 adjacent to each other in the X direction are separated by insulating film 40.

Each of the plurality of insulating films 40 is fixed to cooling plate 23. Specifically, a bonding material 50 is filled in a space between an end of each of the plurality of insulating films 40 on the Z1 side and cooling plate 23. Thus, each of the plurality of power storage cells 11 is indirectly fixed to cooling plate 23 with insulating film 40 interposed therebetween.

Each of the plurality of insulating films 40 is fixed to bottom surface 22a of lower case 22. Specifically, bonding material 50 is filled in a space between an end of each of the plurality of insulating films 40 on the Z2 side and bottom surface 22a. That is, each of the plurality of power storage cells 11 is indirectly fixed to bottom surface 22a with insulating film 40 interposed therebetween.

Removal of the power storage cells from the case is necessary at the time of recycling or the like of the power storage cells. However, in the conventional power storage device, each of the power storage cells is bonded to the case, and thus, removal of each of the power storage cells is difficult.

Thus, in the present embodiment, hollow member 60 is disposed between each of the plurality of power storage cells 11 and cooling plate 23. Hollow member 60 is lower in rigidity than each of power storage cells 11 and case 20. Thus, hollow member 60 is easier to break than each of power storage cells 11 and case 20. As a result, by breaking hollow member 60, cooling plate 23 can be easily separated from the plurality of power storage cells 11. Hollow member 60 is an example of “fragile member” in the present disclosure.

In addition, in the present embodiment, hollow member 60 is also disposed between each of the plurality of power storage cells 11 and bottom surface 22a of lower case 22.

Therefore, in the present embodiment, the fragile portion is formed between each of the plurality of power storage cells 11 and each of cooling plate 23 and bottom surface 22a such that hollow member 60 is disposed at the above-described position.

Hollow member 60 is provided separately from each of the plurality of power storage cells 11. In addition, hollow member 60 is provided separately from case 20. Specifically, hollow member 60 is fixed to each of the plurality of power storage cells 11. Hollow member 60 is not directly in contact with case 20.

Specifically, hollow member 60 is disposed on each of an end face 11a on the Z1 side and an end face 11b on the Z2 side, of each of the plurality of power storage cells 11. Each of end face 11a and end face 11b and hollow member 60 are bonded to each other by a bonding material or the like. Hollow member 60 may only be disposed on each of end face 11a and end face 11b without being bonded to each of end face 11a and end face 11b by the bonding material or the like.

Each of the plurality of insulating films 40 is provided to wrap power storage cell 11, together with hollow member 60. Specifically, each of the plurality of insulating films 40 integrally wraps one power storage cell 11, hollow member 60 disposed on end face 11a of above-described one power storage cell 11, and hollow member 60 disposed on end face 11b of above-described one power storage cell 11. The plurality of insulating films 40 wrap power storage cells 11 different from each other.

As described above, bonding material 50 bonds each of insulating films 40 and case 20 (cooling plate 23 and bottom surface 22a). Therefore, hollow member 60 is indirectly fixed to case 20 (cooling plate 23 and bottom surface 22a) by bonding material 50, with insulating film 40 interposed therebetween.

Although not shown, each of the plurality of insulating films 40 is formed to extend in the Y direction, similarly to power storage cell 11. Thus, power storage cells 11 adjacent to each other can be more reliably separated by insulating film 40. At least one of the Y1 side and the Y2 side of power storage cell 11 (hollow member 60) may be covered with insulating film 40.

Referring again to FIG. 3, hollow member 60 is formed to extend in the Y direction along power storage cell 11. Specifically, hollow member 60 has a prismatic shape extending in the Y direction. A through hole 61 extending in the Y direction is formed in hollow member 60. An opening of through hole 61 has a rectangular shape, for example. The above-described opening has another shape (e.g., circular shape). Alternatively, hollow member 60 may have a cylindrical shape, for example.

Hollow member 60 has a length L11 in the Y direction. Hollow member 60 has a length L12 in the X direction. Length L11 is longer than length L12. Length L11 of hollow member 60 in the Y direction is shorter than length L1 of power storage cell 11 in the Y direction. Length L12 of hollow member 60 in the X direction is shorter than length L2 of power storage cell 11 in the X direction. The size relationship between hollow member 60 and power storage cell 11 is not limited to the above-described example.

A notch 62 serving as a start point of breaking is provided in hollow member 60. A metal fitting for separation 70 (see FIG. 1) disposed at a position in the Z direction corresponding to notch 62 of hollow member 60 on the Z1 side is provided in power storage device 100. Metal fitting for separation 70 is attached to a side surface of each power storage module 10 on the X1 side. Metal fitting for separation 70 is provided to extend in the Y direction along the above-described side surface. For example, when metal fitting for separation 70 is moved to the X2 side by a not-shown jig (device) in a state where metal fitting for separation 70 is grasped by the above-described jig (device), hollow member 60 is cut, starting from notch 62. As a result, upper case 21 is separated from power storage module 10. Metal fitting for separation 70 also serves as an index (mark) indicating the cutting position of hollow member 60. Metal fitting for separation 70 may also be disposed at the position in the Z direction corresponding to notch 62 of hollow member 60 on the Z1 side. Notch 62 is an example of “breaking start point portion” in the present disclosure.

As described above, in the present embodiment, hollow member 60 is disposed between each of the plurality of power storage cells 11 and case 20 (the cooling plate and bottom surface 22a of lower case 22). Thus, by breaking hollow member 60 having a relatively low mechanical strength, case 20 (the cooling plate and bottom surface 22a) can be separated from power storage cell 11. As a result, case 20 can be separated from power storage cell 11 with relatively small force, which allows simplification of the separation process. In addition, a reduction in size (simplification) of the device (jig) used for the above-described separation can be achieved. Therefore, power storage cell 11 can be easily removed from case 20.

Although the example in which hollow member 60 is provided for each power storage cell 11 has been described in the embodiment above, the present disclosure is not limited thereto. Hollow member 60 does not necessarily need to be provided for each power storage cell 11.

For example, as in an example shown in FIG. 5, hollow member 60 is provided over a region where a plurality of (in FIG. 5, two) power storage cells 11 are disposed. In other words, hollow member 60 is disposed to extend over end faces 11a (end faces 11b) of the plurality of power storage cells 11 disposed to be arranged side by side in the X direction. In this case, as shown in FIG. 5, insulating film 40 is not provided.

Alternatively, as a modification of FIG. 5, hollow member 60 may be disposed to extend over the plurality of power storage cells 11 on one of the Z1 side and the Z2 side, and hollow member 60 may be disposed for each power storage cell 11 on the other of the Z1 side and the Z2 side. Alternatively, the plurality of power storage cells 11 and hollow members 60 may be wrapped by one insulating film. Alternatively, the number of power storage cells 11 over which hollow member 60 extends may be three or more.

Although the example in which power storage cell 11 and hollow member 60 are integrally wrapped by insulating film 40 has been described in the embodiment above, the present disclosure is not limited thereto. Insulating film 40 does not necessarily need to be provided.

Although the example in which power storage cell 11 (insulating film 40) is fixed to cooling plate 23 has been described in the embodiment above, the present disclosure is not limited thereto. Cooling plate 23 does not necessarily need to be disposed on the Z1 side of power storage cell 11.

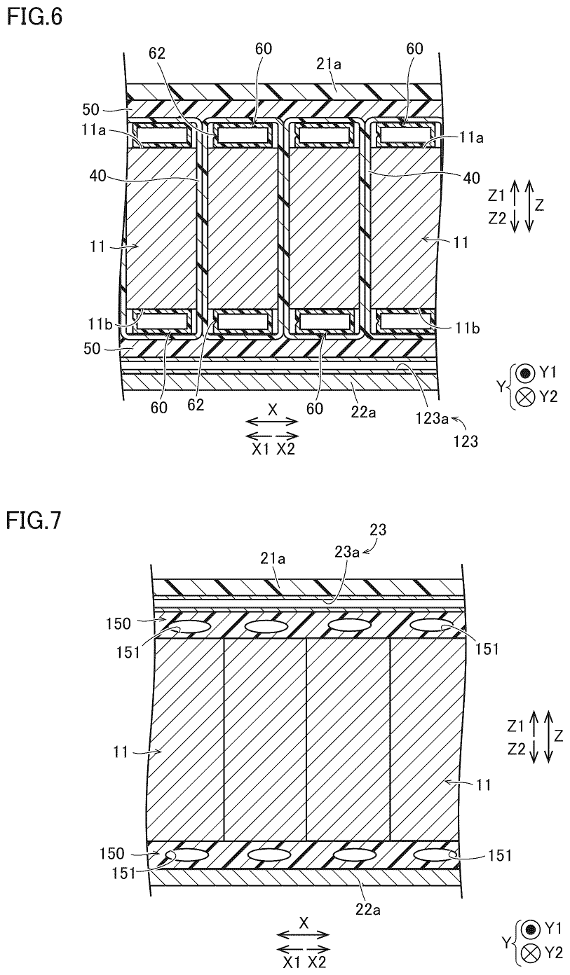

In an example shown in FIG. 6, each of the plurality of power storage cells 11 (insulating films 40) is fixed to upper surface 21a of upper case 21 by bonding material 50. In addition, a cooling plate 123 is provided between bottom surface 22a of lower case 22 and the plurality of power storage cells 11 (insulating films 40). A flow path 123a through which a cooling liquid flows is formed in cooling plate 123. In this case, each of upper surface 21a and cooling plate 123 is an example of “fixed portion” in the present disclosure.

The cooling plate does not necessarily need to be provided on any of the Z1 side and the Z2 side of power storage cell 11.

Although the example in which the fragile portion is formed between power storage cell 11 and case 20 by disposing hollow member 60 between power storage cell 11 and case 20 has been described in the embodiment above, the present disclosure is not limited thereto. The fragile portion may be formed without disposing the fragile member such as hollow member 60.

In an example shown in FIG. 7, instead of disposing hollow member 60, the plurality of power storage cells 11 and case 20 (cooling plate 23 and bottom surface 22a of lower case 22) are bonded to each other by a bonding material 150 having bubbles 151 formed therein. Bubbles 151 are formed between each of the plurality of power storage cells 11 and case 20 (cooling plate 23 and bottom surface 22a). The formation of bubbles 151 results in formation of a fragile portion of bonding material 150. Bubbles 151 may extend in the X direction over a region where the plurality of power storage cells 11 are disposed. In the example shown in FIG. 7, insulating film 40 is not provided. Bubbles 151 are an example of “fragile portion” in the present disclosure.

Although the example in which hollow member 60 is provided separately from each of power storage cell 11 and case 20 has been described in the embodiment above, the present disclosure is not limited thereto. Hollow member 60 may be formed integrally with power storage cell 11 or case 20.

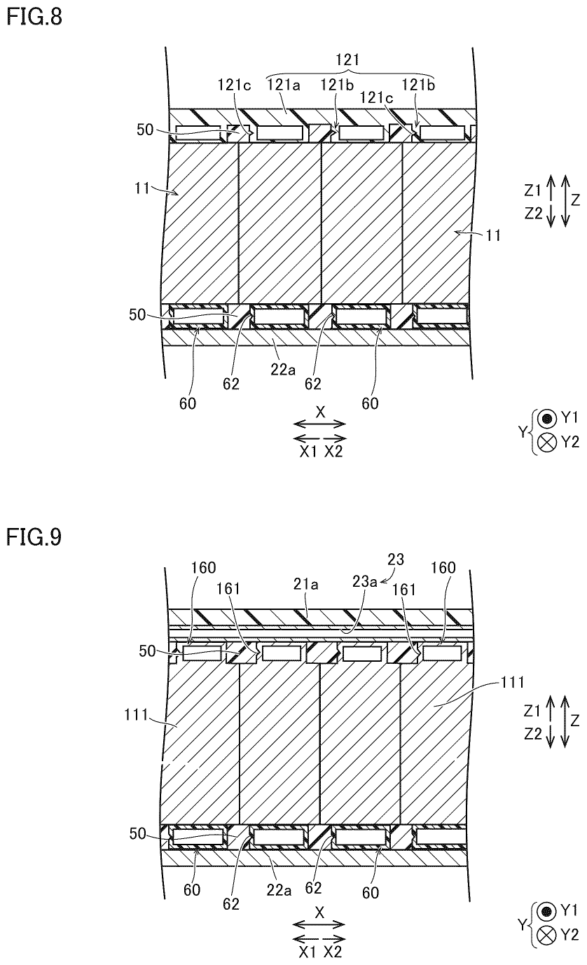

In an example shown in FIG. 8, a hollow portion is formed integrally with the case. An upper case 121 includes an upper surface 121a and a plurality of hollow portions 121b. The plurality of hollow portions 121b are formed integrally with upper surface 121a. Specifically, each of the plurality of hollow portions 121b is provided to protrude from upper surface 121a toward power storage cell 11. A notch 121c is provided in each of hollow portions 121b. Although not shown, the hollow portion may be formed integrally with the lower case, or the hollow portion may be formed integrally with both of the upper case and the lower case. In the example shown in FIG. 8, upper surface 121a is an example of “fixed portion” in the present disclosure. Each of hollow portions 121b is an example of “fragile portion” in the present disclosure.

In an example shown in FIG. 9, the power storage cell is formed integrally with the hollow member. A power storage cell 111 is formed integrally with a hollow member 160. Specifically, hollow member 160 is provided to protrude from power storage cell 111 toward the Z1 side. A notch 161 is provided in hollow member 160.

Although not shown, hollow member 160 may be provided to protrude from power storage cell 111 toward the Z2 side. Hollow member 160 may be provided to protrude from power storage cell 111 toward both of the Z1 side and the Z2 side. Hollow member 160 and notch 161 are examples of “fragile member” and “breaking start point portion” in the present disclosure, respectively.

Although the example in which the fragile portion is formed by disposing hollow member 60 has been described in the embodiment above, the present disclosure is not limited thereto. For example, the fragile portion may be formed by disposing a member that does not have a hollow shape but has a relatively low mechanical strength.

Although the example in which the plurality of power storage cells 11 are provided in power storage module 10 has been described in the embodiment above, the present disclosure is not limited thereto. For example, the power storage module may have only one power storage cell.

Although the example in which the notch is provided as the breaking start point portion in the hollow member has been described in the embodiment above, the present disclosure is not limited thereto. For example, a structure (e.g., a hole) other than the notch may be provided as the breaking start point portion. Alternatively, the breaking start point portion such as the notch does not necessarily need to be provided in the hollow member.

Although the example in which hollow member 60 is disposed on each of the Z1 side and the Z2 side of power storage cell 11 has been described in the embodiment above, the present disclosure is not limited thereto. Hollow member 60 may be disposed on only one of the Z1 side and the Z2 side of power storage cell 11.

It should be noted that the features (processes) of the above-described embodiment and the above-described modifications may be combined with each other.

Although the embodiment of the present disclosure has been described, it should be understood that the embodiment disclosed herein is illustrative and non-restrictive in every respect. The scope of the present disclosure is defined by the terms of the claims, and is intended to include any modifications within the scope and meaning equivalent to the terms of the claims.

What is claimed is:

1. A power storage device comprising:
at least one power storage cell; and
a case that accommodates the at least one power storage cell, wherein
the case includes at least one fixed portion fixed to the at least one power storage cell, and
a fragile portion is formed between the at least one power storage cell and the at least one fixed portion.

2. The power storage device according to claim 1, further comprising
a fragile member having a rigidity lower than that of each of the case and the at least one power storage cell, wherein
the fragile portion is formed by disposing the fragile member between the at least one power storage cell and the at least one fixed portion.

3. The power storage device according to claim 2, wherein
the fragile member includes a hollow member.

4. The power storage device according to claim 2, wherein
the fragile member is provided separately from each of the at least one power storage cell and the case.

5. The power storage device according to claim 2, further comprising
an insulating film provided to wrap the at least one power storage cell, together with the fragile member.

6. The power storage device according to claim 2, wherein
the case includes a cooling device that cools the at least one power storage cell, and
the fragile member is fixed to the cooling device.

7. The power storage device according to claim 2, wherein
a breaking start point portion serving as a start point of breaking is provided in the fragile member.

8. The power storage device according to claim 1, wherein
the at least one power storage cell includes a plurality of power storage cells, and
the fragile portion is formed between each of the plurality of power storage cells and the at least one fixed portion.

9. The power storage device according to claim 1, wherein
the at least one power storage cell includes a plurality of power storage cells,
the plurality of power storage cells are disposed to be arranged side by side in a first direction, and
the fragile portion is formed to extend in the first direction so as to be provided over a region where the plurality of power storage cells are disposed.

10. The power storage device according to claim 1, wherein
the case includes a bottom surface supporting the at least one power storage cell from below, and an upper surface provided to cover the at least one power storage cell from above, and
the at least one fixed portion includes at least one of the bottom surface and the upper surface.

11. The power storage device according to claim 1, wherein
the at least one power storage cell has a prismatic shape formed to extend in a second direction, and
the fragile portion is formed to extend in the second direction along the at least one power storage cell.
